(19) United States
(12) Patent Application Publication
(10) Pub. No.: US 2006/0087840 A1
(43) Pub. Date: Apr. 27, 2006

(54) Hybrid lighting system

(76) Inventors: James Bruce Franklin, Camperdown (AU); Geoffrey Burton Smith, Epping (AU)

Correspondence Address: LADAS & PARRY LLP, 224 SOUTH MICHIGAN AVENUE, SUITE 1600, CHICAGO, IL, 60604, US

(21) Appl. No.: 10/534,668

(22) PCT Filed: Nov. 14, 2003
(86) PCT No.: PCT/AU03/01510

§ 371 Date: May 11, 2005

(30) Foreign Application Priority Data
Nov. 14, 2002 (AU) 2002952652

(51) Int. Cl. F21S 19/00

(52) U.S. Cl. 362/228

(57) ABSTRACT

The present invention provides a hybrid lighting system that comprises at least one light collector for generating an output of fluorescent light. The light collector comprises an optically transmissive material that is doped with dispersed dye molecules which are arranged to absorb incoming solar light and to emit fluorescence light. The hybrid lighting system also comprises at least one electrically powered light emitting device that, in use, supplements the output of the light collector to providing light of a predetermined spectral characteristic.

### FIELD OF THE INVENTION

The present invention broadly relates to a lighting system and particularly, though not exclusively, to a daylight collection system.

### BACKGROUND OF THE INVENTION

Electrical lighting systems are often very inefficient; usually more than 90% of the electrical energy is not converted into useful light. Sunlight, however, is freely available and attempts have been made to collect sunlight for illumination purposes.

U.S. Pat. No. 6,059,438 discloses a sunlight collecting and transmitting system. The disclosed system includes three substantially flat collector sheets. The three sheets are stacked on top of each other and are composed of a polymeric material that is doped with dye molecules. The dye molecules absorb sunlight of a particular wavelength and subsequently emit fluorescent light having a slightly larger wavelength. A first sheet is doped with blue light emitting dye molecules, a second sheet is doped with green dye molecules and a third sheet is doped with red or orange-red dye molecules. The generated fluorescent light is guided by total internal reflection within the collector sheets and white light can be generated by combining the red, green and blue fluorescent light. One of the advantages of this sunlight collecting and transmitting system is that the absorption of the incoming light occurs with reasonable efficiency for all incident directions and the emission of the fluorescent light occurs in arbitrary directions. The efficiency of such a system therefore is largely independent of whether the incoming sunlight is diffuse or specular (that is direct from the sun).

The main contribution to emitted lumens of light is from the green spectral range. The human eye is far less sensitive to red and blue light. In a typical system the main amount of light therefore is provided by light collectors doped with dye molecules that emit green light whereas light collectors doped with dye molecules that emit red or blue light typically provide less lumens. However, in order to generate white light, at least a moderate lumen output of red and blue light is required.

### SUMMARY OF THE INVENTION

The present invention provides in a first aspect a hybrid lighting system comprising:

at least one light collector for generating an output of fluorescent light, the light collector comprising an optically transmissive material that is doped with dispersed dye molecules which are arranged to absorb incoming solar light and to emit fluorescent light and

at least one electrically powered light emitting device that, in use, supplements the output of the light collector to providing light of a predetermined spectral characteristic.

The or each electrically powered light emitting device may be arranged to supplement the emitted fluorescence radiation by providing light of at least one particular colour such that the addition of the light from the or each electrically powered light emitting device to the emitted fluorescent light results in light having a predetermined colour. The predetermined colour typically is white.

For example, the hybrid lighting system may comprise a light collector sheet that emits green fluorescence light. The green fluorescence light may in use be supplemented by red and blue light emitting devices such a light emitting diodes (LEDs) to generate white light. In this case, the blue LED arrangement may be arranged to emit approximately 2-20% of the total amount of generated by the system and the red LED arrangement may be arranged to emit approximately 15-30% of the total amount of lumens generated by the system.

Alternatively, the hybrid lighting system may comprise light collector sheets that emit green and red light. The green and red fluorescence light may in use be supplemented by blue light emitting devices such as LEDs to generate the white light. In this case only approximately 2-20% of the total amount of lumens generated by the system is required from the blue light emitting device. This arrangement has the particular advantage that no light collector is required for the emission of blue light. Blue fluorescent dyes often do not have good quantum conversion efficiencies and usually need to be pumped with UV light (sunlight includes only a relatively small component of UV light). Further, there are often stability problems with blue dye molecules. It can therefore be difficult to generate even the relatively small intensities of blue light. Thus, supplementing fluorescent light with blue light from an electrically powered light emitting device, such as a light emitting diode (LED), can facilitate the generation of white light.

Colour rendering may also be improved if emitted fluorescent light is supplemented by blue light from an electrically powered light-emitting device. Colour and intensity shifts of emitted light over time may also occur if one type of the dyes changes the output relative to another type of the dyes due to slow degradation.

The arrangement comprising a blue light emitting device has the further advantage that only two light collectors are required for the generation of white light which reduces cost as it simplifies the hybrid lighting system, especially as then associated light guides are less expensive, smaller in cross section and more flexible.

With such a hybrid systems the generation of say 1000 lumens of white light requires relatively little electrical energy and therefore is inexpensive. In contrast, the generation of 1000 lumens of white light using solar cells and electrically powered light emitting devices requires a power of approximately 30 W and the required solar cells and electrically powered light emitting devices are relatively expensive.

In a specific embodiment the hybrid lighting system comprises an optical cable that is arranged to guide light from the or each light collector and the or each electrically powered light emitting device. In this embodiment one of three colours required for the generation of white light is generated by the electrically powered light source. In this case the optical cable can have a cross-sectional area through which, in use, light is guided that is reduced by approximately ⅓ compared to a lighting system in which all colours for the generation of the white light are generated by light collector sheets.

In another example two of the colours are generated by electrically powered light sources. In this case the optical cable may have a cross-sectional area through which, in use, light is guided that is reduced by approximately ⅔ compared to a lighting system in which all colours for the generation of the white light are generated by light collector sheets.

The or each electrically powered light emitting device may also be arranged to supplement for an intensity deficiency of the output. In addition to supplementing a spectral characteristic, the electrically powered light emitting device may also be arranged to provide light within the same colour range as that of the emitted fluorescence radiation. In this case, the hybrid lighting system may comprise electrically powered light emitting devices that are arranged for the emission of red, green and blue light and the hybrid lighting system may include light collectors arranged for the emission of light of some these colours. In this case the light collectors may be used to provide illumination at daytime, supplemented by at least one of the light emitting devices, while at night time the electrically powered light emitting devices are used to provide illumination. For example, at daytime green fluorescence light may be provided by the light collector supplemented by light emitted from the red and blue electrically powered light emitting devices while at night time light is provided from the electrically powered light emitting devices only.

The hybrid lighting system may comprise at least one light guide and the or each electrically powered light emitting device may be coupled to the or each light guide by means of a prism, an optical fibre or a lens. The or each electrically powered light emitting device may also be implanted into the or respective ones of the light guides. Optionally, the or each electrically powered light emitting device is coupled to a respective light transmissive sheet that is in coupled to the or each respective light guide.

The hybrid lighting system may also comprise a luminaire arranged to emit light and wherein the light from the or each electrically powered light emitting device may be mixed within the luminaire with light from the or each light collector sheet. The or each light collector sheet may be coupled to the luminaire without an intervening separate light guide.

For example, the or each electrically powered light emitting device may be mounted in, or adjacent to, the luminaire which is used to emit light and to which the or each light guide may be coupled. In any case coupling may be effected such that light from the electrically powered light emitting device and fluorescent light are added to each other.

The or each electrically powered light emitting device may be powered by a battery or another energy storage device. The or each electrically powered light emitting device may also be powered by a solar cell. Alternatively, the battery or the other storage device may be charged by the solar cell and the hybrid lighting system may be arranged to provide stand-alone 24 hour lighting or lighting-on-demand.

The output of the or each electrically powered light emitting device in combination with the output from the or each light collector may be controllable to generate light of controlled colour shades.

The light output from the or each electrically powered light emitting device and the output from the or each light collector sheet may also be controllable to generate a substantially constant illumination during clear day conditions, cloudy or night time conditions.

A property of the output may be electronically controlled. For example, the output may be controllable such that, largely independent on weather conditions and daytime, illumination of predetermined lumens is generated. The output may be controllable such that illumination of predetermined lumens is generated in a manner to reduce energy consumption.

In one specific embodiment, the device comprises more than one light emitting devices of the or each colour that is in use supplemented.

Specific embodiments will now be described, by way of example only, with reference to the accompanying drawings.

### BRIEF DESCRIPTION OF THE DRAWINGS

FIGS. 1 (a) and (b) show perspective views of a hybrid lighting system according a first embodiment,

FIGS. 2 (a) and (b) show perspective views of a hybrid lighting system according a second embodiment,

FIGS. 3 (a) and (b) show perspective views of a hybrid lighting system according a third embodiment,

FIGS. 4 shows a perspective view of a hybrid lighting system according a fourth embodiment,

FIGS. 5 (a) and (b) show perspective views of a hybrid lighting system according a fifth embodiment and

FIGS. 6 shows (a) a perspective view, (b) an in-part cross-sectional view and (c) a side view of a hybrid lighting systems according to further embodiments.

### DETAILED DESCRIPTION OF SPECIFIC EMBODIMENTS

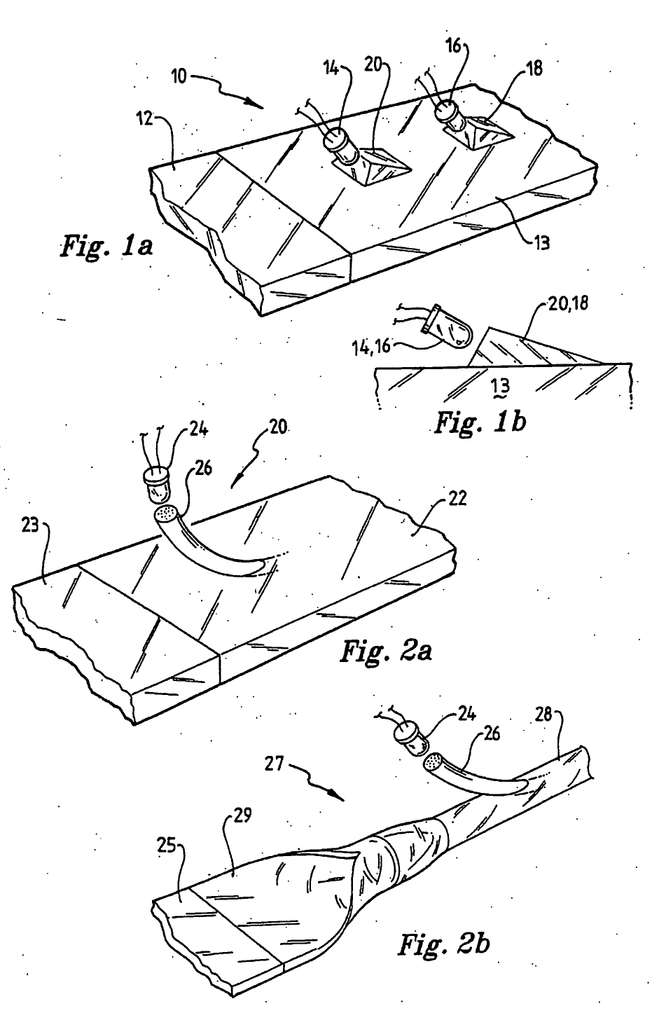

Initially referring to FIGS. 1 (a) and 1 (b), the hybrid lighting system 10 according to a first embodiment is now described. FIG. 1 shows a light collector sheet 12 and a light guide 13. Light collector sheet 12 and light guide 13 are joined face-to-face. The light collector sheet 12 and the light guide 13 are composed of a transparent plastics material and the light collector sheet 12 is doped with dye molecules that absorb incoming daylight and emit fluorescent radiation.

In general the light collector sheet 12 is analogous to those disclosed in U.S. Pat. No. 6,059,438. This patent discloses a system that includes three of such flat sheets. The three sheets are stacked on top of each other and are composed of a polymeric material that is doped with dye molecules. The dye molecules absorb sunlight of a particular wavelength and subsequently emit fluorescent light having a slightly larger wavelength. A first sheet is doped with blue light emitting dye molecules, a second sheet is doped with green light emitting dye molecules and a third sheet is doped with red or orange-red light emitting dye molecules. The generated fluorescent light is guided by total internal reflection within the collector sheets and white light can be generated by combining the red, green and blue fluorescent light.

In the example shown in FIG. 1, the light collector sheet 12 is doped with dye molecules that absorb incoming radiation and subsequently emit green light and the green light is supplemented by the light generated by light emitting diodes. One light emitting diode (LED) 14 emits blue light and one LED 16 emits red light. The light from LEDs 14 and 16 is coupled to the light guide 13 by means of prisms 18 and 20. The LEDs 14 and 16 are powered by a power source (not shown) and, in use, the power is controlled such that, together with the green fluorescent light emitted by the dye molecules, white light is generated. It will be appreciated that the LEDs 14 and 16 may be coupled to the light guide using other means for coupling.

In a variation of this embodiment, sheet 12 is a stack of light collector sheets. For example, the stack may comprise light collector sheets arranged for the emission of green and one of blue or red light. In this case only one electrically powered light emitting device supplements the emitted fluorescence light.

As a further example FIGS. 2 (a) and 2 (b) show a hybrid lighting system according to a second embodiment. The hybrid lighting system 20 shows a LED 24 which is coupled to the light guide 22 by means of an optical fibre 26. Light guide 22 is connected to a light collector sheet 23. FIG. 2 (b) shows a variation of this embodiment. The Figure shows hybrid system 27 coupled to a light guide that is provided in form of an optical cable 28. The LED 24 is coupled to the optical cable 28 by means of the optical fibre 26. The optical cable 28 is connected to a light collector 25 by means of a coupler 29. The coupler 29 is arranged to couple light from the substantially flat sheet 25 to the optical cable 28 and is described in the applicant's co-pending patent application entitled “A light transfer component” which claims priority from Australian provisional patent application no. 2002952276.

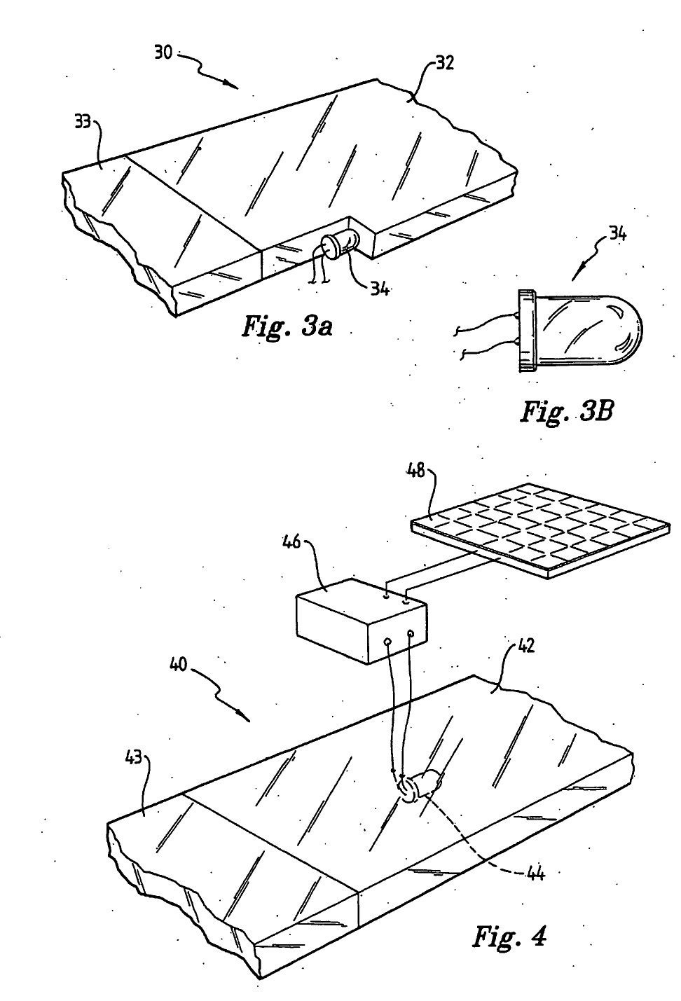

FIGS. 3 (a) and (b) show a third embodiment in which a hybrid lighting system 30 comprises a light guide 32 that is coupled to a light collector sheet 33. An LED 34 is coupled to the light guide 32 and arranged to supplement the fluorescence light generated in the light collector sheet 33 and guided through the light guide 32.

FIG. 4 shows a fourth embodiment of in which the hybrid lighting system 40 comprising a light guide 42 coupled to a light collector sheet 43. A LED 44 is implanted into the light guide 42. In this case the LED 44 is powered by a battery 46 that accumulates charges provided by a solar cell 48.

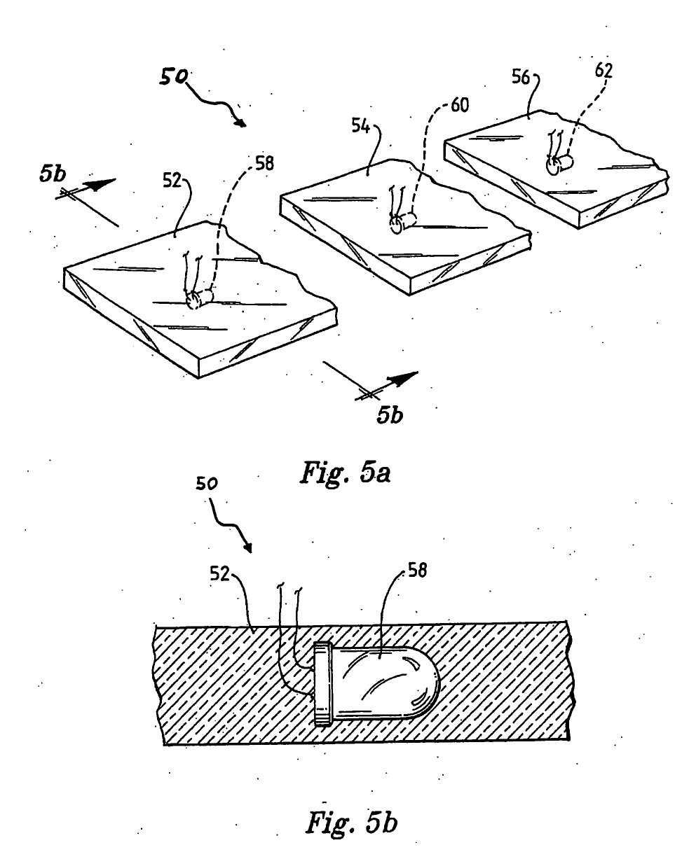

The light collector system may comprise a plurality of light collector sheets and LEDs which relates to the fifth embodiment shown in FIGS. 5 (a) and (b). In this embodiment, the hybrid lighting system 50 comprises light guides 52, 54 and 56 which are connected to respective light collector sheets (not shown) that are arranged for the emission of red, green and blue fluorescent light, respectively. LEDs 58, 60 and 62 are implanted into the light guides 52, 54 and 56 and are also arranged for the emission of red, green and blue light. In this case the light collector sheets 52, 54 and 56 may be used to provide illumination during daytime and the LEDs may be used to provide illumination during night time.

Alternatively, one or more of the light collector sheets may be used together with one or more of the LEDs. In a specific variation of this embodiment the LEDs are placed alongside (or within) a luminare that is attached to an end of each light guide and through which light is emitted for illumination purposes. In any case, The LEDs are positioned such that fluorescent light and LED light mixes.

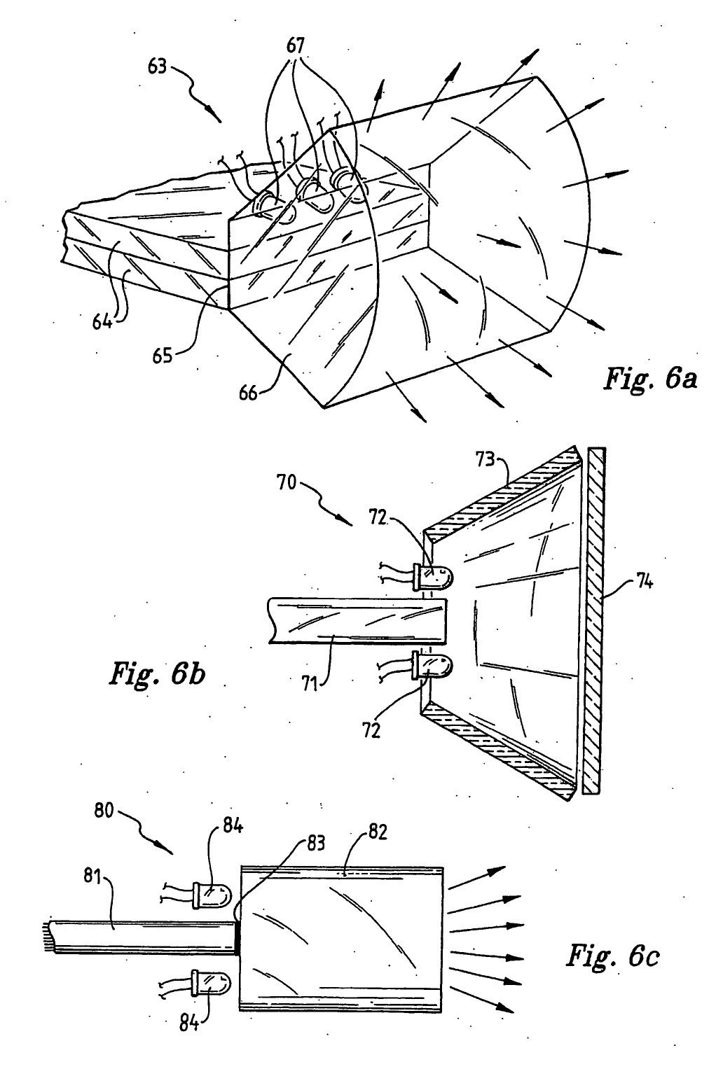

In a specific variation of the previous embodiments, the LEDs are placed alongside (or within) a luminare that is attached to an end of the or each light guide and through which light is emitted for illumination purposes. A part of such a system is shown in FIG. 6 (a). In this embodiment, the hybrid lighting system 63 comprises light guides 64 which are connected to respective light collector sheets (not shown) that are arranged for the emission of red and green fluorescent light. The light guides 64 are connected by optical joint 65 to the luminaire 66. Typically the shape of the luminaire 66 is chosen so that the cross sectional area of the or each exit surface exceeds the cross sectional area of the entry surface. U.S. Pat. No. 6,272,265 teaches that this can enhance the release of otherwise trapped fluorescent radiation from the optical system. The LEDs 67 are positioned such that fluorescent light and LED light mixes. Typically the fluorescent light and LED light mixes within the luminaire. In a specific variation of this embodiment the LEDs may be placed within the luminare. In a typical embodiment the LEDs 67 emit blue light of an intensity and spectral distribution that combines with the red and green fluorescent light from light guides 64 to make white light. Optionally the luminaire 66 may be fabricated from a diffusing material. A suitable material is PMMA doped with particles of cross-linked. PMMA in the size range of 5 microns to 50 microns.

In a variation of this embodiment, the light guides 64 are collector sheets. Collector sheets tend to have significantly reduced optical transmission of their fluorescent emission compared to that of dedicated light guides. So this embodiment is not suitable for situations requiring a long distance between the position where the solar radiation is collected and the place where light is emitted from the luminare 66. An advantage of this embodiment is the elimination of the joint(s) between separate light guide(s) and collector sheet(s).

An alternative embodiment is shown in FIG. 6 (b). In this embodiment, the hybrid lighting system 70 comprises optical cable 71 which is connected to light collector sheets (not shown) that are arranged for the emission of red and green fluorescent light. Light from the optical cable 71 enters the approximately conical luminaire 73 which has reflecting sides and a diffuser plate 74 located at the end opposite the optical cable 71. The LEDs 72 are positioned such that fluorescent light and LED light mixes. The optional diffuser plate 74 improves the degree of mixing and uniformity of the output. A suitable material for the diffuser plate 74 is PMMA doped with particles of cross-linked PMMA in the size range of 5 microns to 50 microns. In a typical embodiment the LEDs 72 emit blue light of an intensity and spectral distribution that combines with the red and green fluorescent light from optical cable 71 to make white light. In a variation of this embodiment, the light cable 71 is one or more collector sheets.

An alternative embodiment is shown in FIG. 6 (c). In this embodiment, the hybrid lighting system 80 comprises optical cable 81 which is connected to light collector sheets (not shown) that are arranged for the emission of red and green fluorescent light. Light from the optical cable 81 enters the mixer unit 82 via the optical joint 83. LEDs 84 are positioned such that fluorescent light and LED light mixes. U.S. Pat. No. 6,272,265 teaches that the use of a scattering material in the mixer unit 82 can enhance the release of otherwise trapped fluorescent radiation from the optical system. The design of mixer units 82 is described in the co-pending patent application entitled “Light Emitting Device” which claims priority from Australian provisional patent application 2002951465. A suitable material for the mixer unit 82 is PMMA doped with particles of cross-linked PMMA in the size range of 5 microns to 50 microns. Typically, the LEDs 84 emit blue light of an intensity and spectral distribution that combines with the red and green fluorescent light from optical cable 81 to make white light.

It will be appreciated that alternatively the optical cable 81 may guide light of any colour such as light from a green light collector sheet only. In this case the LEDs 84 are arranged for the emission of blue and red light. The optical cable 81 may also guide light form green and blue light collector sheets in which case the LEDs 84 are arranged for the emission of red light.

In a variation of this embodiment, the light cable 81 is one or more collector sheets.

Although the invention has been described with reference to particular examples, it will be appreciated by those skilled in the art that the invention may be embodied in many other forms. For example, each light collector sheet 12, 23, 25, 33, 43, 52, 54 and 56 may be one of a stack of light collector sheets that may be doped with the same type or with different types of light emitting dye molecules. Similarly, the stack of light guides 64 may be a single light guide. Further, the system may comprise electrically powered light emitting devices other than LEDs. In addition, each light emitting diode 14, 16, 24, 34, 44, 58, 60, 62, 67, 72 and 84 may be one of a plurality of light emitting diodes. In the shown examples, each LED is provided in form of a package that comprises a lens. It will be appreciated that alternatively the LEDs may not comprise lenses. The LED light may for example be coupled into a light guide using an auxiliary lens positioned between the LED and the light guide. It will also be appreciated that the light guides may not be provided in form of a flat sheets. Further, it will be appreciated that the light cables may not have round cross-sectional shapes but may alternatively have any other suitable cross-sectional shape such as rectangular shapes. For example, the light cables 71 and 81 may be in the form of flat sheets.

Further, the system 50 may comprise any number of light collector sheets. Further, the electrically powered light emitting devices may be optically linked to light guides or to the light collector sheets themselves using any suitable means.

It is to be understood that the reference that is made to U.S. Pat. Nos. 6,059,438, 6,272,265, the applicants co-pending patent application entitled “A light transfer component” and patent application 2002951465 does not constitute an admission that the documents form a part of the common general knowledge in the art, in Australia or any other country.

1-28. (canceled)

29. A hybrid lighting system comprising:
at least one light collector for generating an output of fluorescent light, the light collector comprising an optically transmissive material that is doped with dispersed dye molecules which are arranged to absorb incoming light and to emit fluorescent light; and
at least one electrically powered light emitting device that, in use, supplements the output of the light collector to providing light of a predetermined spectral characteristic.

30. The hybrid lighting system as claimed in claim 29 wherein the or each electrically powered light emitting device is arranged to supplement the emitted fluorescence radiation by providing light of at least one particular colour such that the addition of the light from the or each electrically powered light emitting device to the emitted fluorescent light results in light having a predetermined colour.

31. The hybrid lighting system as claimed in claim 30 wherein the predetermined colour is white.

32. The hybrid lighting system as claimed in claim 29 comprising a light collector sheet that in use emits green fluorescence light and the green fluorescence light is supplemented by red and blue light emitting devices.

33. The hybrid lighting system as claimed in claim 32 wherein the blue light emitting device is arranged to emit approximately 2-20% of the total amount of lumens generated by the system and the red light emitting device is arranged to emit approximately 15-30% of the total amount of lumens generated by the system.

34. The hybrid lighting system as claimed in claim 29 comprising light collector sheets that emit green and red light and in use the green and red fluorescence light is supplemented by light from a blue light emitting device.

35. The hybrid lighting system as claimed in claim 34 wherein the blue light emitting device is arranged to emit approximately 2-20% of the total amount of lumens generated by the system.

36. The hybrid lighting system as claimed in claim 29 comprising an optical cable that is arranged to guide light from the or each light collector and the or each electrically powered light emitting device.

37. The hybrid lighting system as claimed in claim 36 wherein one of three colours required for the generation of white light is generated by the electrically powered light source and the optical cable has a cross-sectional area through which, in use, light is guided and that is reduced by approximately ⅓ compared to a lighting system in which all colours for the generation of the white light are generated by light collector sheets.

38. The hybrid lighting system as claimed in claim 36 wherein two of the colours are generated by electrically powered light sources and the optical cable has a cross-sectional area through which, in use, light is guided and that is reduced by approximately ⅔ compared to a lighting system in which all colours for the generation of the white light are generated by light collector sheets.

39. The hybrid lighting system as claimed in claim 29 wherein the or each electrically powered light emitting device is also arranged to supplement for an intensity deficiency of the output.

40. The hybrid lighting system as claimed in claim 39 comprising electrically powered light emitting devices that are arranged for the emission of red, green and blue light.

41. The hybrid lighting system as claimed in claim 29 comprising at least one light guide and wherein the or each electrically powered light emitting device is coupled to the or each light guide by means of a prism.

42. The hybrid lighting system as claimed in claim 29 comprising at least one light guide and wherein the or each electrically powered light emitting device is coupled to the or each light guide by means of an optical fibre.

43. The hybrid lighting system as claimed in claim 29 comprising at least one light guide and wherein the or each electrically powered light emitting device is coupled to the or each light guide by means of a lens.

44. The hybrid lighting system as claimed in claim 29 wherein the or each electrically powered light emitting device is implanted into the or a respective ones of the light guides.

45. The hybrid lighting system as claimed in claim 29 wherein the or each electrically powered light emitting device is coupled to a respective light transmissive sheet that is coupled to the or each respective light guide.

46. The hybrid lighting system as claimed in claim 29 comprising a luminaire arranged to emit light and wherein the light from the or each electrically powered light emitting device is mixed within the luminaire with light from the or each light collector sheet.

47. The hybrid lighting system as claimed in claim 46 in which the or each light collector sheet is coupled to the luminaire without an intervening separate light guide.

48. The hybrid lighting system as claimed in claim 29 wherein the or each electrically powered light emitting device is mounted in a luminaire which is used to emit light and to which the or each light guide is coupled.

49. The hybrid lighting system as claimed in claim 29 wherein the or each electrically powered light emitting device is mounted adjacent to a luminaire which is used to emit light and to which the or each light guide is coupled.

50. The hybrid system as claimed in claim 29 wherein the or each electrically powered light emitting device is powered by a battery.

51. The hybrid system as claimed in claim 29 wherein the or each electrically powered light emitting device is powered by a solar cell.

52. The hybrid system as claimed in claim 50 wherein the battery is charged by a solar cell.

53. The hybrid lighting system as claimed in claim 29 wherein the output of the or each electrically powered light emitting device in combination with the output from the or each light collector is controllable to generate light of controlled colour shades.

54. The hybrid lighting system as claimed in claim 29 the wherein a property of the output is electronically controlled.

55. The hybrid lighting system as claimed in claim 30 comprising more than one light emitting devices of the or each particular colour that is in use supplemented.

56. The hybrid lighting system as claimed in claim 29 wherein the or each light emitting device is a light emitting diodes (LED).
